(19) United States
(12) Patent Application Publication
(10) Pub. No.: US 2025/0296726 A1
(43) Pub. Date: Sep. 25, 2025

(54) Carton With Insert

(71) Applicant: Graphic Packaging International, LLC, Atlanta, GA (US)

(72) Inventor: Steven M. Oliveira, Canton, GA (US)

(21) Appl. No.: 19/084,943

(22) Filed: Mar. 20, 2025

Related U.S. Application Data
(60) Provisional application No. 63/567,481, filed on Mar. 20, 2024.

(51) Int. Cl. B65D 5/32; B31B 50/26; B31B 105/00; B31B 120/10; B31B 120/30; B65D 5/54; B65D 5/66

(52) U.S. Cl. CPC B65D 5/326; B31B 50/262; B65D 5/543; B65D 5/6608; B31B 2105/00; B31B 2120/102; B31B 2120/302

(57) ABSTRACT

A carton for holding one or more products. The carton can comprise a plurality of panels extending at least partially around an interior of the carton. The plurality of panels can comprise at least a front panel and an opposing back panel. The carton further can comprise a sidewall comprising at least a portion of the front panel and the back panel and a lid comprising at least a portion of the front panel and the back panel. The lid can be separable from the sidewall along an opening feature extending in at least the front panel. The carton also can comprise an insert in an overlapping relationship with at least a portion of the front panel. The carton further can comprise a closing feature extending in the insert for at least partially retaining the lid in a reclosed position.

### CROSS-REFERENCE TO RELATED APPLICATIONS

This application claims the benefit of U.S. Provisional Patent Application No. 63/567,481, filed on Mar. 20, 2024.

### INCORPORATION BY REFERENCE

The disclosures of U.S. Provisional Patent Application No. 63/547,697, which was filed on Nov. 8, 2023, and U.S. Provisional Patent Application No. 63/567,481, which was filed on Mar. 20, 2024, are hereby incorporated by reference for all purposes as if presented herein in their entirety.

### BACKGROUND OF THE DISCLOSURE

The present disclosure generally relates to cartons for holding and dispensing products and to methods of forming the cartons. More specifically, the present disclosure is directed to cartons with inserts and with opening and reclosing features.

### SUMMARY OF THE DISCLOSURE

In general, one aspect of the disclosure is directed to a carton for holding one or more products. The carton can comprise a plurality of panels extending at least partially around an interior of the carton. The plurality of panels can comprise at least a front panel and an opposing back panel. The carton further can comprise a sidewall comprising at least a portion of the front panel and the back panel and a lid comprising at least a portion of the front panel and the back panel. The lid can be separable from the sidewall along an opening feature extending in at least the front panel. The carton also can comprise an insert extending along at least a portion of the interior of the carton. The insert can be in an overlapping relationship with at least a portion of the front panel. The carton further can comprise a closing feature extending in the insert for at least partially retaining the lid in a reclosed position.

In another aspect, the disclosure is generally directed to, in combination, a carton blank and an insert blank for forming a carton for holding one or more products. The carton blank can comprise a plurality of panels for extending at least partially around an interior of the carton formed by the carton blank and the insert blank. The plurality of panels can comprise at least a front panel and a back panel, and the insert blank can be in an overlapping relationship with at least a portion of the front panel. An opening feature can extend in at least the front panel, the opening feature being for at least partially defining a lid separable from a sidewall along the opening feature when the carton is formed from the carton blank and the insert blank. Each of the lid and the sidewall can be for comprising at least a portion of the front panel and the back panel when the carton is formed from the carton blank and the insert blank. A closing feature can extend in the insert, and the closing feature can be for at least partially retaining the lid in a reclosed position when the carton is formed from the carton blank and the insert blank.

In another aspect, the disclosure is generally directed to a method of forming a carton. The method can comprise obtaining a carton blank and an insert blank. The carton blank can comprise a plurality of panels, and the plurality of panels can comprise at least a front panel and a back panel. A closing feature can extend in the insert. The method further can comprise positioning the insert blank in an overlapping relationship with at least a portion of the front panel and forming the carton by positioning the plurality of panels to extend at least partially around an interior of the carton with the insert blank forming an insert extending along at least a portion of the interior of the carton. The forming the carton can comprise at least partially forming a sidewall comprising at least a portion of the front panel and the back panel and a lid comprising at least a portion of the front panel and the back panel. The lid can be separable from the sidewall along an opening feature extending in at least the front panel, and the closing feature can be for at least partially retaining the lid in a reclosed position.

Additional aspects, features, and advantages of the present invention will become apparent from the following description and accompanying figures.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a carton blank used for at least partially forming a carton according to exemplary embodiments of the disclosure.

FIG. 2 is a plan view of an insert blank for at least partially forming an insert for cooperating with the carton according to the exemplary embodiments of the disclosure.

FIG. 3 is a plan view of the insert blank of FIG. 2 attached to the carton blank of FIG. 1 to form a combined blank according to the exemplary embodiments of the disclosure.

FIGS. 4 and 5 are perspective views showing the formation of the carton from the combined blank of FIG. 3 according to the exemplary embodiments of the disclosure.

FIGS. 6 and 7 are perspective views of the carton formed from the combined blank of FIG. 3 according to the exemplary embodiments of the disclosure.

FIG. 8 is a perspective view of the carton of FIGS. 6 and 7 in an open configuration according to the exemplary embodiments of the disclosure.

FIG. 9 is a perspective view of the carton of FIGS. 6-8 in a reclosed configuration according to the exemplary embodiments of the disclosure.

Corresponding parts are designated by corresponding reference numbers throughout the drawings.

### DETAILED DESCRIPTION OF THE EXEMPLARY EMBODIMENTS

The present disclosure generally relates to constructs, boxes, cartons, carriers, trays, or the like, and packages for holding one or more products or articles such as those including pre-portioned pouches, pods, tablets, capsules, etc. and/or any other product(s). The product or products can be cleaning products such as laundry pods, dishwashing agents, household cleaners, soaps, and the like; cat litter and/or other suitable granular and/or flowable materials; medicines; cosmetics; candles; tobacco; food items; any other suitable product or material; or combinations thereof.

Cartons according to the present disclosure can accommodate product or articles of any shape. In this specification, the terms “inner,” “interior,” “outer,” “exterior,” “lower,” “bottom,” “upper,” and “top” indicate orientations determined in relation to fully erected and upright cartons. As described herein, cartons can be formed from blanks with multiple panels, flaps, portions, tabs, lines of weakening, edges, openings, and/or other suitable aspects, which may be designated herein in terms relative to one another, e.g., “first,” “second,” “third,” etc., in sequential or nonsequential reference, without departing from the disclosure.

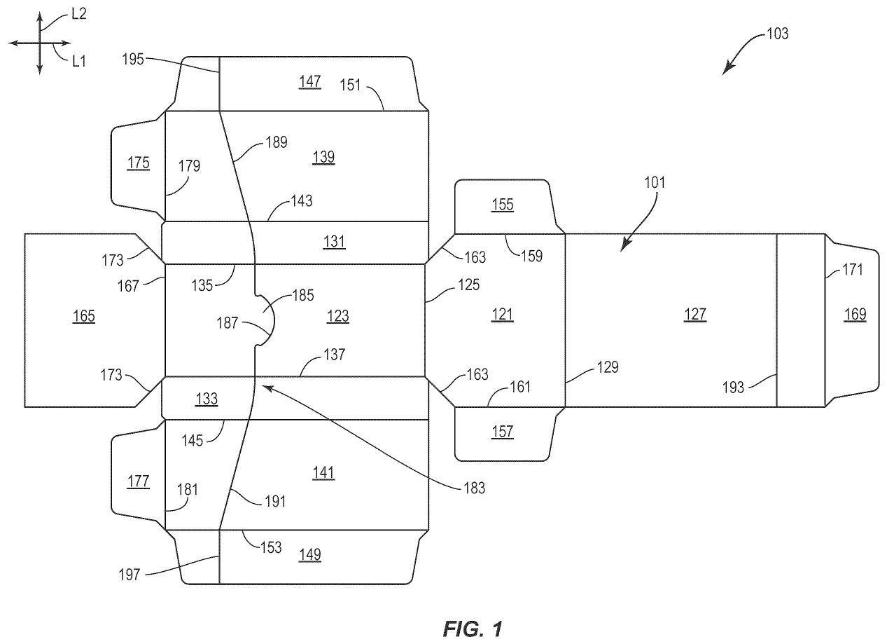

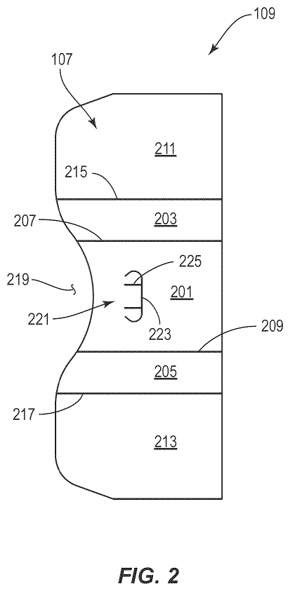

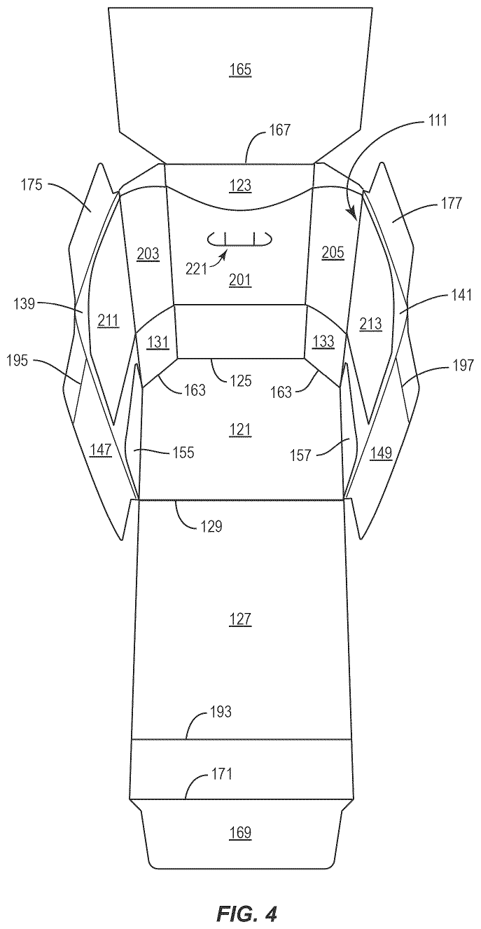

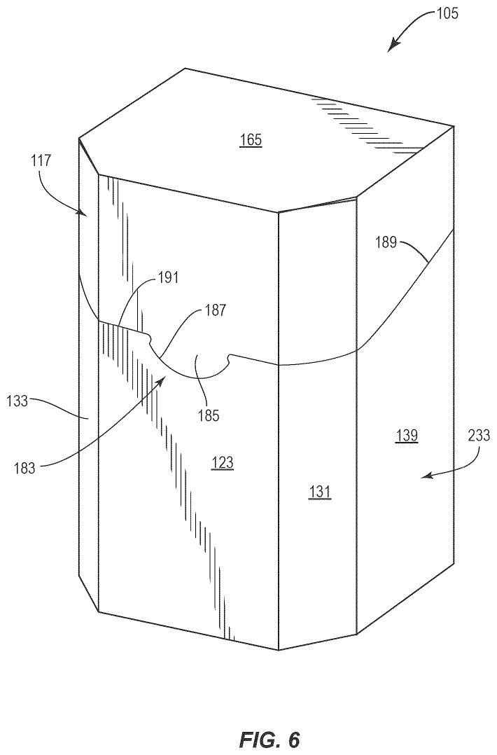

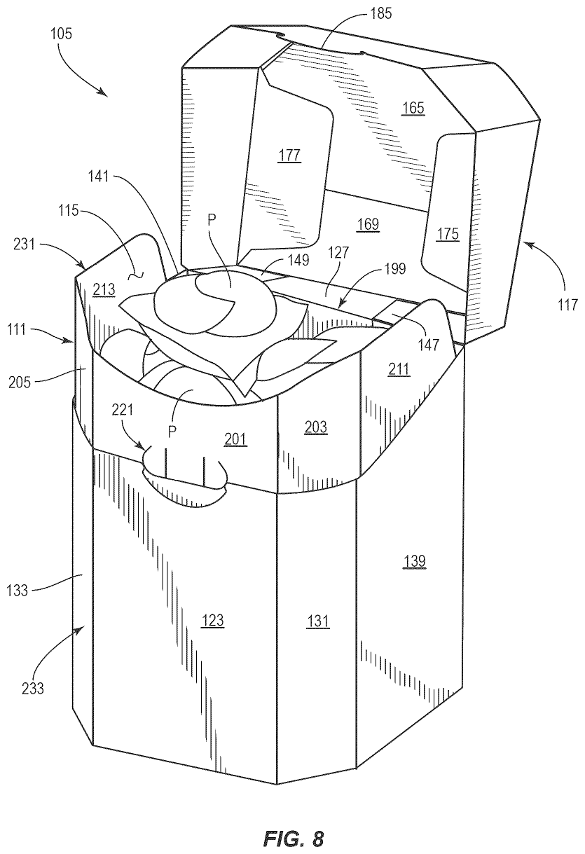

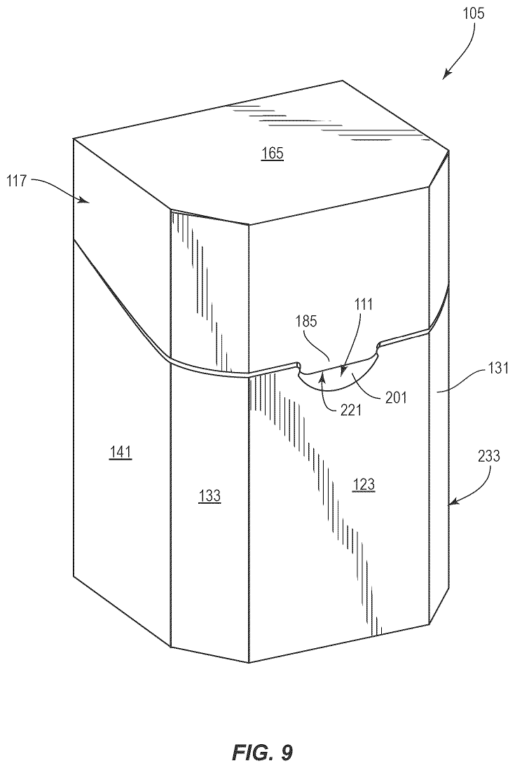

FIG. 1 illustrates an exterior surface 101 of a first blank or carton blank 103 for forming a container or carton 105 (FIGS. 6-9) used to hold one or more products P (e.g., FIG. 8). FIG. 2 illustrates an exterior surface 107 of a second or insert blank 109 used to form a second part or insert 111 (e.g., a second construct 111) (FIGS. 4, 5, 8, and 9). In the illustrated embodiments, the insert 111 can cooperate with the carton 105 to at least partially retain the products P in an interior 115 of the carton 105 when a lid 117 of the carton 105 is moved to an open position (FIG. 8). In embodiments, the lid 117 can be actuated by operating (e.g., tearing) one or more opening features (e.g., tear lines) to at least partially open the carton 105 (FIG. 8), and the lid 117 can be reclosed and at least partially retained in the reclosed position by one or more retaining features (FIG. 9), as described in more detail below.

In the illustrated embodiments, the carton blank 103 has a longitudinal axis L1 and a lateral axis L2. The carton blank 103 can include a bottom panel 121 foldably connected to a front panel 123 along a first lateral fold line 125 and to a back panel 127 along a second lateral fold line 129. A first corner panel 131 and a second corner panel 133 can be respectively foldably connected to the front panel 123 along respective longitudinal fold lines 135, 137, and a first side panel 139 and a second side panel 141 can be foldably connected to the respective first corner panel 131 and second corner panel 133 along respective longitudinal fold lines 143, 145. Attachment flaps 147, 149 can be foldably connected to the respective side panels 139, 141 along respective longitudinal fold lines 151, 153. The bottom panel 121, front panel 123, the back panel 127, the corner panels 131, 133, the side panels 139, 141, and/or the attachment flaps 147, 149 could be otherwise shaped, arranged, positioned, and/or configured without departing from the disclosure.

As shown in FIG. 1, the carton blank 103 can include one or more bottom flaps (e.g., a plurality of bottom flaps) foldably connected to the bottom panel 121. For example, a first bottom flap 155 and a second bottom flap 157 can be foldably connected on opposite sides of the bottom panel 121 along respective longitudinal fold lines 159, 161. In embodiments, the bottom panel 121 can include bottom oblique edges 163 extending from respective ends of the lateral fold line 125 to ends of the respective longitudinal fold lines 159, 161. Further, as shown in FIG. 1, the carton blank 103 can include a plurality of top flaps foldably connected to respective panels of the plurality of panels. For example, a front top flap 165 (e.g., an outer top flap) can be foldably connected to the front panel 123 along a lateral fold line 167 opposite to the bottom panel 121, and a back top flap 169 can be foldably connected to the back panel 127 along a lateral fold line 171 opposite to the bottom panel 121. In embodiments, the front top flap 165 can include top oblique edges 173 extending from respective ends of the lateral fold line 167 and aligned with the respective bottom oblique edges 163 of the bottom panel 121. The plurality of top flaps further can include side top flaps 175, 177 foldably connected to the respective side panels 139, 141 along respective lateral fold lines 179, 181. Any of the bottom flaps 155, 157 and/or the top flaps 165, 169, 175, 177 could be omitted or could be otherwise shaped, arranged, positioned, and/or configured without departing from the disclosure.

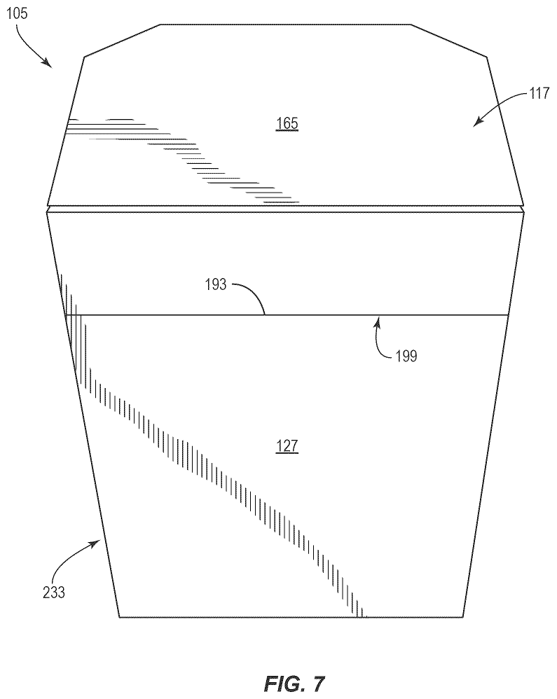

As shown in FIG. 1, the carton blank 103 can include opening features 183 for forming the lid 117 (FIGS. 6-9). In the illustrated embodiments, the opening features 183 can include a locking/opening tab 185 extending in the front panel 123 and at least partially defined by an at least partially curved cut or tear line 187 (e.g., a cut line interrupted by a plurality of nicks or any other suitable line of weakening). As shown in FIG. 1, the opening features 183 further can include curved and/or oblique cut or tear lines 189, 191 (e.g., cut lines interrupted by a plurality of nicks or any other suitable line of weakening) extending from respective ends of the tear line 187 in the front panel 123, at least partially across the respective corner panels 131, 133 and the respective side panels 139, 141. In embodiments, the opening features 183 can include a lateral fold line 193 extending in the back panel 127 and lateral fold lines 195, 197 extending in the respective attachment flaps 147, 149. In exemplary embodiments, the lateral fold lines 195, 197 can extend from respective ends of the tear lines 189, 191. In the illustrated embodiments, the lateral fold lines 195, 197 can be in an at least partially overlapping relationship with the lateral fold line 193 when the carton 105 is formed from the carton blank 103 so that the lateral fold lines 193, 195, 197 cooperate to at least partially form a hinge 199 (FIGS. 7 and 8). The opening features 183, including any of the tab 185, the tear lines 187, 189, 191, the fold lines 193, 195, 197, and/or the hinge 199, could be omitted or could be otherwise shaped, arranged, positioned, and/or configured without departing from the disclosure.

As shown in FIG. 2, the insert blank 109 can include a central panel 201 foldably connected to opposing inner corner panels 203, 205 along respective fold lines 207, 209. In embodiments, end panels 211, 213 can be foldably connected to the respective inner corner panels 203, 205 opposite to the central panel 201 along respective fold lines 215, 217. In the illustrated embodiments, the insert blank 109 can include a curved top edge extending along at least a portion of the central panel 201 and the corner panels 203, 205 to at least partially define a cutout 219. Any of the central panel 201, the inner corner panels 203, 205, the end panels 211, 213, and/or the cutout 219 could be omitted or could be otherwise shaped, arranged, positioned, and/or configured without departing from the disclosure.

In the illustrated embodiments, the insert blank 109 can include a closing feature 221 extending in the central panel 201 for cooperating with the tab 185 in the lid 117 for reclosing the lid 117 (FIG. 9). In exemplary embodiments, the closing feature 221 can include a cut line or slot 223, which can have curved (e.g., semicircular) ends, and two cuts 225 extend from the slot 223 between its curved ends. The closing feature 221 could be omitted or could be otherwise shaped, arranged, positioned, and/or configured without departing from the disclosure.

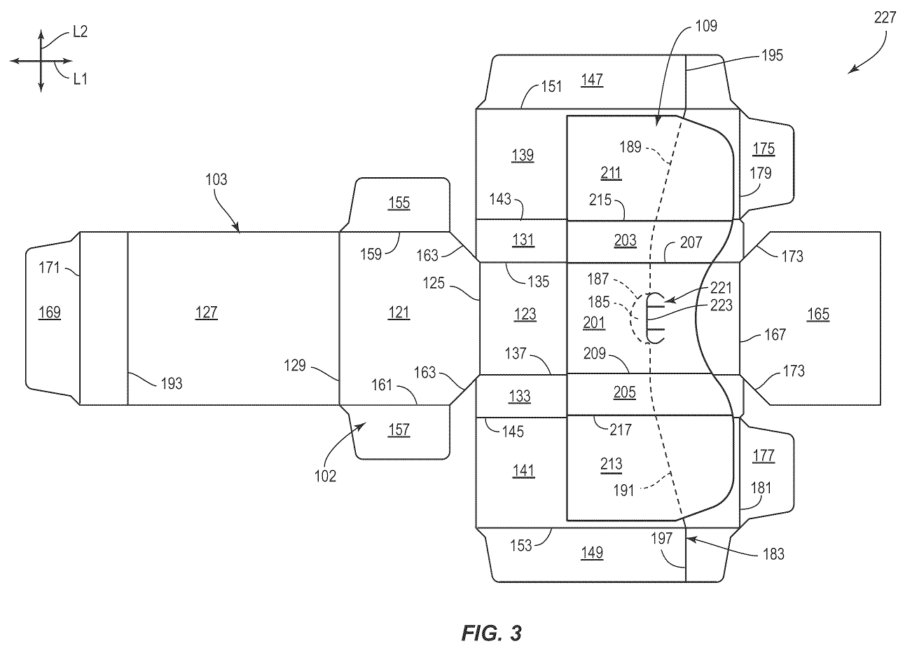

As shown in FIG. 3, the insert blank 109 can be a tipped-in element with respect to the carton blank 103. For example, the insert blank 109 can be in an overlapping relationship with the carton blank 103 wherein the exterior surface 107 of the insert blank 109 is at least partially in face-to-face contact with the interior surface 102 of the carton blank 103. For example, the front panel 123, the corner panels 131, 133, and the side panels 139, 141 of the carton blank 103 can at least partially overlap the respective central panel 201, inner corner panels 203, 205, and end panels 211, 213. In embodiments, the insert blank 109 can be attached (e.g., glued and/or otherwise secured) to the interior surface 102 of the carton blank 103 (e.g., one or more panels of the insert blank 109 can be attached to one or more panels of the carton blank 103). As shown in FIG. 3, the insert blank 109 can be aligned with the carton blank 103 so that the closing feature 221 is proximate to and aligned with the tab 185 in the front panel 123 and so that the cutout 219 in the insert blank 109 is proximate to and aligned with the top portion of the front panel 123 and the top flap 165.

In the illustrated embodiments, the insert blank 109 and the carton blank 103 can cooperate to form a flat construct or combined blank 227. The combined blank 227 could be otherwise formed without departing from the disclosure.

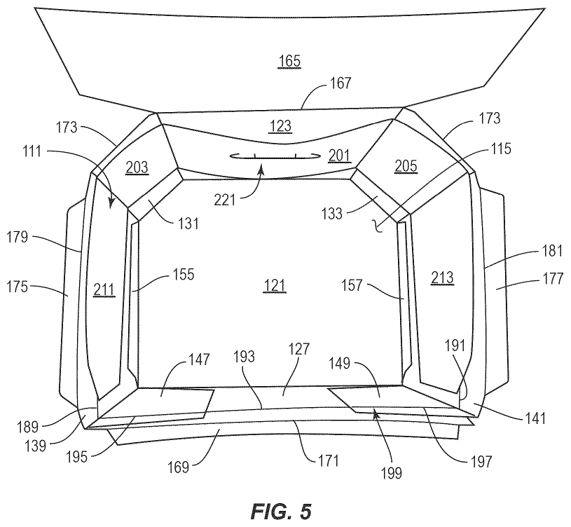

As shown in FIGS. 4-6, the carton 105 can be formed from the combined blank 227 (e.g., including the carton blank 103 and the tipped-in insert blank 109). For example, the combined blank 227 can be folded along the lateral fold line 125 so that the front panel 123 extends at least upwardly from the bottom panel 121, and the corner panels 131, 133 can be folded along the longitudinal fold lines 135, 137 to extend obliquely with respect to the front panel 123 and to extend at least partially along the respective bottom oblique edges 163 of the bottom panel 121. As shown in FIG. 4, the side panels 139, 141 can be folded along the respective longitudinal fold lines 143, 145 so that the side panels 139, 141 are perpendicular to the front panel 123. In addition, the bottom flaps 155, 157 can be folded upwardly with respect to the bottom panel 121 along the respective longitudinal fold lines 159, 161 so that the bottom flaps 155, 157 extend along the interior 102 of the side panels 139, 141. In alternative embodiments, the bottom flaps 155, 157 can be folded upwardly before or after the side panels 139, 141 are folded to extend along the bottom panel 121 so that the bottom flaps 155, 157 extend on an interior or exterior side of the side panels 139, 141. As shown in FIG. 5, the back panel 127 can be folded upwardly with respect to the bottom panel 121 along the lateral fold line 129 and the attachment flaps 147, 149 can be folded inwardly along the respective longitudinal fold lines 151, 153 so that the back panel 127 and the attachment flaps 147, 149 are in an overlapping relationship. For example, the attachment flaps 147, 149 could be attached (e.g., glued or otherwise secured) to the interior 102 of the back panel 127 with the lateral fold lines 195, 197 extending along respective portions of the lateral fold line 193 to at least partially form the hinge 199. In alternative embodiments, the attachment flaps 147, 149 could be secured to an exterior 101 of the back panel 127 without departing from the disclosure.

As shown in FIG. 5, a plurality of panels of the carton 105 (e.g., the bottom panel 121, the front panel 123, the back panel 127, the corner panels 131, 133, the end panels 139, 141, and the attachment flaps 147, 149) can extend along the interior space 115 of the carton 105. Further, the insert blank 109 can be folded along the fold lines 207, 209, 215, 217 to at least partially form the insert 111 (FIGS. 4 and 5) when the carton blank 103 is folded into the carton 105. As shown in FIG. 5, the insert 111 can extend along the interior space 115 on the interior side 102 of the carton 105. In embodiments, the product(s) P can be loaded into the interior 115 of the carton 105 via the open top end of the carton 105.

In the illustrated embodiments, the carton 105 further can be formed by folding the top side flaps 175, 177 along the lateral fold lines 179, 181 over the open top end, the back top flap 169 can be folded along the lateral fold line 171 to at least partially overlap the side top flaps 175, 177, and the front top flap 165 can be folded along the lateral fold line 167 to at least partially overlap the back top flap 169 and the side top flaps 175, 177 as shown in FIGS. 5 and 8. In embodiments, the front top flap 165 can be attached (e.g., glued and/or otherwise secured) to one or more of the back top flap 169 and the side top flaps 175, 177. The carton 105 could be otherwise formed without departing from the disclosure.

The assembled and erected carton 105 is shown in FIGS. 6 and 7. In the illustrated embodiments, the lid 117 can be at least partially defined in the top portion of the carton 105 by the opening features 183 (e.g., including the tear lines 187, 189, 191 and the hinge 199) and can include the top wall of the carton 105 at least partially defined by the top flaps 165, 169, 175, 177.

As shown in FIG. 8, the lid 117 can be opened by tearing along the tear lines 187, 189, 191 (e.g., by pressing inwardly on the tab 185 and then grasping and pulling outwardly and/or upwardly on the tab 185) and pivoting the lid 117 upwardly along the hinge 199. In embodiments, the portions of the front panel 123, the corner panels 131, 133, and the side panels 139, 141 included in the lid 117 are not secured to the insert 111 (e.g., only portions of one or more of the panels 123, 131, 133, 139, 141 below the opening features 183 are attached to the insert 111) so that the lid 117 can slide upwardly and/or rearwardly relative to the insert 111. As shown in FIG. 8, opening the lid 117 can form a dispensing opening 231 in the carton 105 for providing access to the products P in the container 105.

In exemplary embodiments, the portions of the front panel 123, the corner panels 131, 133, the side panels 139, 141, and the back panel 127 below the tear lines 187, 189, 191 can at least partially define a sidewall 233 extending around the interior 115 of the carton 105. As shown in at least FIG. 8, the insert 111 can extend upwardly from the sidewall 233 along the interior 115 of the carton 205 and along the dispenser opening 231. In embodiments, the insert 111 can help hold the articles P in the interior 115 of the carton 105 when the lid 117 is in the open position (FIG. 8). The carton 105 could be otherwise be opened and/or provide access to the interior 115 without departing from the disclosure.

As shown in FIG. 9, the lid 117 can be reclosed by pivoting the lid 117 downwardly along the hinge 199 over the dispenser opening 231 with portions of the lid 117 sliding over the portion of the insert 111 extending upwardly from the sidewall 233. In embodiments, the tab 185 extending downwardly from the lid 117 in the reclosed position (FIG. 9) can be inserted into the slot 223 in the central panel 201 of the insert 111 to help retain the lid 117 in the reclosed configuration (FIG. 9). The carton 105 could be otherwise be reclosed without departing from the disclosure.

In the illustrated embodiments, the opening features 183 of the carton 105 can provide tamper evidence in the event that the carton 105 was opened and/or was attempted to be opened previously. For example, an observer can see that the tear lines 187, 189, 191 have been torn in the event that the carton 105 was previously opened and then reclosed. Such tamper evidence may provide the user with an indication that the contents of the carton may have been accessed (e.g., tampered with and/or removed) prior to intended use.

In general, the blanks of the present disclosure may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding there along. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for holding one or more products, the carton comprising:
a plurality of panels extending at least partially around an interior of the carton, the plurality of panels comprising at least a front panel and an opposing back panel;
a sidewall comprising at least a portion of the front panel and the back panel;
a lid comprising at least a portion of the front panel and the back panel, wherein the lid is separable from the sidewall along an opening feature extending in at least the front panel;
an insert extending along at least a portion of the interior of the carton, wherein the insert is in an overlapping relationship with at least a portion of the front panel; and
a closing feature extending in the insert for at least partially retaining the lid in a reclosed position.

2. The carton of claim 1, wherein the insert is glued to one or more panels of the plurality of panels.

3. The carton of claim 1, wherein the lid is hinged to the sidewall along at least a fold line extending in the back panel.

4. The carton of claim 3, wherein the opening feature comprises a tear line extending in panels of the plurality of panels and having an end that is proximate the fold line in the back panel.

5. The carton of claim 1, wherein the opening feature comprises a tear line in the front panel, the tear line at least partially defining a tab in the front panel so that the tab extends from the lid after the lid is separated from the sidewall along the opening feature.

6. The carton of claim 5, wherein the closing feature comprises a slot in the insert, the slot is positioned to at least partially receive the tab extending from the lid when the lid is in the reclosed position.

7. The carton of claim 1, further comprising a plurality of top flaps foldably connected to respective panels of the plurality of panels, wherein the top flaps are at least partially overlapped to close a top end of the carton, and wherein the lid comprises the top end.

8. The carton of claim 1, wherein the plurality of panels comprises a corner panel foldably connected to the front panel and a side panel foldably connected to the corner panel, wherein the insert comprises a central panel foldably connected to an inner corner panel and an end panel foldably connected to the inner corner panel, and wherein the central panel is in an at least partially overlapping relationship with the front panel, the inner corner panel is in an at least partially overlapping relationship with the corner panel, and the end panel is in an at least partially overlapping relationship with the side panel.

9. The carton of claim 1, wherein the insert extends along at least a portion of the sidewall and along at least a portion of the lid when the carton is in a closed configuration, and wherein the insert extends upwardly from the sidewall when the lid is pivoted open.

10. The carton of claim 1, wherein the plurality of panels comprises a bottom panel, the front panel is foldably connected to the bottom panel, and the back panel is foldably connected to the bottom panel opposite to the front panel.

11. The carton of claim 10, wherein the plurality of panels comprises a side panel foldably connected to an attachment flap, and wherein the attachment flap is in an overlapping relationship with the back panel.

12. In combination, a carton blank and an insert blank for forming a carton for holding one or more products, the carton blank comprising:
a plurality of panels for extending at least partially around an interior of the carton formed by the carton blank and the insert blank, the plurality of panels comprising at least a front panel and a back panel, wherein the insert blank is in an overlapping relationship with at least a portion of the front panel; and
an opening feature extending in at least the front panel, the opening feature being for at least partially defining a lid separable from a sidewall along the opening feature when the carton is formed from the carton blank and the insert blank, and wherein each of the lid and the sidewall is for comprising at least a portion of the front panel and the back panel when the carton is formed from the carton blank and the insert blank;
wherein a closing feature extends in the insert, and the closing feature is for at least partially retaining the lid in a reclosed position when the carton is formed from the carton blank and the insert blank.

13. The combination of claim 12, wherein the insert is glued to one or more panels of the plurality of panels.

14. The combination of claim 12, wherein the carton blank comprises a fold line extending in the back panel, and the lid is for being hinged to the sidewall along at least the fold line when the carton is formed from the carton blank and the insert blank.

15. The combination of claim 14, wherein the opening feature comprises a tear line extending in panels of the plurality of panels.

16. The combination of claim 12, wherein the opening feature comprises a tear line in the front panel, the tear line at least partially defining a tab in the front panel, and wherein the tab is for extending from the lid after the lid is separated from the sidewall along the opening feature when the carton is formed from the carton blank and the insert blank.

17. The combination of claim 16, wherein the closing feature comprises a slot in the insert blank, and wherein the insert blank is positioned on the carton blank so that the slot at least partially overlaps the tab in the front panel.

18. The combination of claim 12, wherein the carton blank further comprises a plurality of top flaps foldably connected to respective panels of the plurality of panels, and wherein the top flaps are for being at least partially overlapped to close a top end of the carton formed from the carton blank and the insert blank.

19. The combination of claim 12, wherein the plurality of panels comprises a corner panel foldably connected to the front panel and a side panel foldably connected to the corner panel, wherein the insert comprises a central panel foldably connected to an inner corner panel and an end panel foldably connected to the inner corner panel, and wherein the central panel is in an at least partially overlapping relationship with the front panel, the inner corner panel is in an at least partially overlapping relationship with the corner panel, and the end panel is in an at least partially overlapping relationship with the side panel.

20. The combination of claim 12, wherein the plurality of panels comprises a bottom panel, the front panel is foldably connected to the bottom panel, and the back panel is foldably connected to the bottom panel opposite to the front panel.

21. A method of forming a carton, the method comprising:
obtaining a carton blank and an insert blank, the carton blank comprising a plurality of panels, wherein the plurality of panels comprises at least a front panel and a back panel, wherein a closing feature extends in the insert;
positioning the insert blank in an overlapping relationship with at least a portion of the front panel;
forming the carton by positioning the plurality of panels to extend at least partially around an interior of the carton with the insert blank forming an insert extending along at least a portion of the interior of the carton, wherein the forming the carton comprises at least partially forming a sidewall comprising at least a portion of the front panel and the back panel and a lid comprising at least a portion of the front panel and the back panel, wherein the lid is separable from the sidewall along an opening feature extending in at least the front panel, and wherein the closing feature is for at least partially retaining the lid in a reclosed position.

22. The method of claim 21, wherein the carton blank comprises a fold line extending in the back panel, and the lid is hinged to the sidewall along at least the fold line when the carton is formed.

23. The method of claim 21, wherein the opening feature comprises a tear line in the front panel, the tear line at least partially defining a tab in the front panel, and wherein the tab is for extending from the lid after the lid is separated from the sidewall along the opening feature.

24. The method of claim 23, wherein the closing feature comprises a slot in the insert blank, and wherein the positioning the insert blank in an overlapping relationship with at least a portion of the front panel comprises positioning the slot and the tab to be in an at least partially overlapping relationship so that the slot is configured to at least partially receive the tab extending from the lid when the lid is in the reclosed position.

25. The method of claim 21, wherein the carton blank further comprises a plurality of top flaps foldably connected to respective panels of the plurality of panels, wherein the forming the carton further comprises positioning the top flaps to be at least partially overlapped to close a top end of the carton, and wherein the lid comprises the top end.

26. The method of claim 21, wherein the plurality of panels comprises a corner panel foldably connected to the front panel and a side panel foldably connected to the corner panel, wherein the insert comprises a central panel foldably connected to an inner corner panel and an end panel foldably connected to the inner corner panel, and wherein the positioning the insert blank comprises positioning the central panel in an at least partially overlapping relationship with the front panel, positioning the inner corner panel in an at least partially overlapping relationship with the corner panel, and positioning the end panel in an at least partially overlapping relationship with the side panel.

27. The method of claim 21, wherein the insert extends along at least a portion of the sidewall and along at least a portion of the lid when the carton is in a closed configuration, and wherein the insert extends upwardly from the sidewall when the lid is pivoted open.

28. The method of claim 21, wherein the plurality of panels comprises a bottom panel and a side panel, the front panel is foldably connected to the bottom panel, and the back panel is foldably connected to the bottom panel opposite to the front panel, and wherein the side panel is foldably connected to an attachment flap, and the forming the carton comprises positioning the attachment flap in an overlapping relationship with the back panel.
